(19) United States
(12) Patent Application Publication
(10) Pub. No.: US 2014/0064817 A1
(43) Pub. Date: Mar. 6, 2014

(54) TENSION CONTROL IN A WEB TRANSPORT SYSTEM

(71) Applicants: Thomas Niertit, Webster, NY (US); Randy E. Armbruster, Rochester, NY (US); Lothar J. Schroeder, West Chester, OH (US); Scott P. MacKenzie, Brockport, NY (US)

(72) Inventors: Thomas Niertit, Webster, NY (US); Randy E. Armbruster, Rochester, NY (US); Lothar J. Schroeder, West Chester, OH (US); Scott P. MacKenzie, Brockport, NY (US)

(21) Appl. No.: 13/768,488

(22) Filed: Feb. 15, 2013

Related U.S. Application Data
(60) Provisional application No. 61/696,848, filed on Sep. 5, 2012.

(51) Int. Cl. B41J 13/00

(52) U.S. Cl. CPC B41J 13/0009
USPC 400/583.4

(57) ABSTRACT

A method for controlling tension in a print media in a tension zone of a printing system comprises enabling an active tension control mode until the tension in the print media is in a stable state for a given period of time. Then, the active tension control mode is disabled and a synchronized control mode is enabled. The tension in the print media is monitored to determine if the tension exceeds a tension inner band but does not exceed a tension outer band while the synchronized control mode is enabled. The speed of a drive roller is adjusted in response to this determination. The tension in the print media is also monitored to determine if the tension exceeds the tension outer band while the synchronized control mode is enabled. The synchronized control mode is disabled in response to this determination and the active tension control mode is enabled.

### CROSS REFERENCE TO RELATED APPLICATIONS

This application claims the benefit of U.S. Provisional Application No. 61/696,848 filed Sep. 5, 2012.

Reference is made to commonly-assigned, U.S. application Ser. No. ______ (Docket K001475), entitled “METHOD FOR CONTROLLING TENSION IN A WEB”, filed concurrently herewith.

### FIELD OF THE INVENTION

The present invention generally relates to web transport systems used in printing systems and more particularly to controlling tension in a continuous web in a web transport system.

### BACKGROUND OF THE INVENTION

In high speed inkjet printers, a media transport is used to move a web of print media past a plurality of printheads. The printheads are positioned sequentially along the media path to print each of the plurality of ink colors. The web of print media is kept under tension as it is moved along the media path. Prior art systems, such as the Kodak Versamark 100 series printers have used a proportional integrate derivative (PID) control algorithm to maintain the tension of the print media as it is moved through the printing system. High quality print requires that the print from each of these printheads be properly registered to each other. It has been found that in some printing applications, depending, for example, on ink coverage levels and the ink and print media types, that the registration of the plurality of printheads along the direction of the media travel can vary unacceptably when using a PID control algorithm to maintain the tension of the print media as it is moved through the printing system. There is a need for an improved method for moving the print media relative to the plurality of printheads to improve the registration of the print from the plurality of printheads.

### SUMMARY OF THE INVENTION

A method for controlling tension in a print media in a tension zone of a continuous web printing system comprises enabling an active tension control mode when initial transport of the print media begins and until the tension in the print media in the tension zone is in a stable state for a given period of time, disabling the active tension control mode and enabling a synchronized control mode after the tension in the print media in the tension zone is in the stable state for the given period of time, monitoring the tension in the print media in the tension zone to determine if the tension exceeds a tension inner band and does not exceed a tension outer band while the synchronized control mode is enabled and adjusting a speed of a drive roller in response to the determination that the tension exceeds the tension inner band and does not exceed the tension outer band, and monitoring the tension in the print media in the tension zone to determine if the tension exceeds the tension outer band while the synchronized control mode is enabled, disabling the synchronized control mode in response to the determination that the tension exceeds the tension outer band, and enabling the active tension control mode.

An advantage of the present invention is that it provides better control over adjusting the tension in the print media in the tension zone, thus reducing the amount of stretch in the print media. This allows for better registration of the plurality of printheads in the printing system, resulting in a higher quality print.

### BRIEF DESCRIPTION OF THE DRAWINGS

FIG. 1 is a graphical illustration of in-track color misalignment;

FIG. 2 is a schematic side view of one example of a continuous web printing system;

FIG. 3 illustrates a top perspective view of one example of a turnover module in an embodiment in accordance with the invention;

FIG. 4 is a flowchart of a method for controlling tension in a continuous web in a web transport system in an embodiment in accordance with the invention; and

FIG. 5 is one example of a plot of the tension and tension control bands in an embodiment in accordance with the invention.

### DETAILED DESCRIPTION OF THE INVENTION

The following terms take the meanings explicitly associated herein, unless the context clearly dictates otherwise. The meaning of “a,” “an,” and “the” includes plural reference, the meaning of “in” includes “in” and “on.”Additionally, directional terms such as “on”, “over”, “top”, “bottom”, “left”, “right” are used with reference to the orientation of the Figure(s) being described. Because components of embodiments of the present invention can be positioned in a number of different orientations, the directional terminology is used for purposes of illustration only and is in no way limiting.

The present description will be directed in particular to elements forming part of, or cooperating more directly with, an apparatus in accordance with the present invention. It is to be understood that elements not specifically shown, labeled, or described can take various forms well known to those skilled in the art. It is to be understood that elements and components can be referred to in singular or plural form, as appropriate, without limiting the scope of the invention.

The example embodiments of the present invention are illustrated schematically and not to scale for the sake of clarity. One of ordinary skill in the art will be able to readily determine the specific size and interconnections of the elements of the example embodiments of the present invention.

As described herein, the example embodiments of the present invention apply to controlling tension in a continuous web in a web transport system as the web is transported through a system. The web transport system is adapted to operate in at least two tension control modes, an active tension control mode and a synchronized tension control mode. In the active tension control mode, one or more settings (e.g., speed, position) of a component or components can be adjusted to increase or decrease the tension in the web in a tension zone while the web is transported through the system. In the synchronized tension control mode, the operation of tension-adjusting or tension-controlling components is synchronized while the web is transported through a tension zone. A tension zone is an area of a web transport system where controlling the tension of a web is desired.

The invention is described herein in conjunction with an inkjet printing system, and the continuous web is the print media. Other embodiments in accordance with the invention can control tension in different types of webs in different types of systems, such as, for example, a film coating or finishing machine or a packaging machine. With respect to an inkjet printing system, inkjet printing is commonly used for printing on paper, where paper is the print media. However, there are numerous other materials in which inkjet is appropriate. For example, vinyl sheets, plastic sheets, textiles, paperboard, and corrugated cardboard can comprise the print media. Additionally, although the term inkjet is often used to describe the printing process, the term jetting is also appropriate wherever ink or other liquids is applied in a consistent, metered fashion, particularly if the desired result is a thin layer or coating.

Many other applications are emerging which use inkjet printheads to emit liquids (other than inks) that need to be finely metered and deposited with high spatial precision. Such liquids include inks, both water based and solvent based, that include one or more dyes or pigments. These liquids also include various substrate coatings and treatments, various medicinal materials, and functional materials useful for forming, for example, various circuitry components or structural components. As such, as described herein, the terms “liquid” and “ink” refer to any material that is ejected by a printhead or printhead components described below.

Inkjet printing is a non-contact application of an ink to a print media. The invention described herein is applicable to both drop on demand ink jet (DOD) and continuous ink jet (CU) printing technologies. As such, the terms linehead and printhead, as used herein, are intended to be generic and not specific to either technology. Additionally, the terms linehead, printhead, print media, and web can be applied to other nontraditional inkjet applications, such as printing conductors on plastic sheets or medicines or materials on skin.

And as discussed earlier, a web transport system can be used in systems other than inkjet printing systems. As such, the term “web” can be applied to any continuous transport surface or medium that is moved through a system using a web transport system.

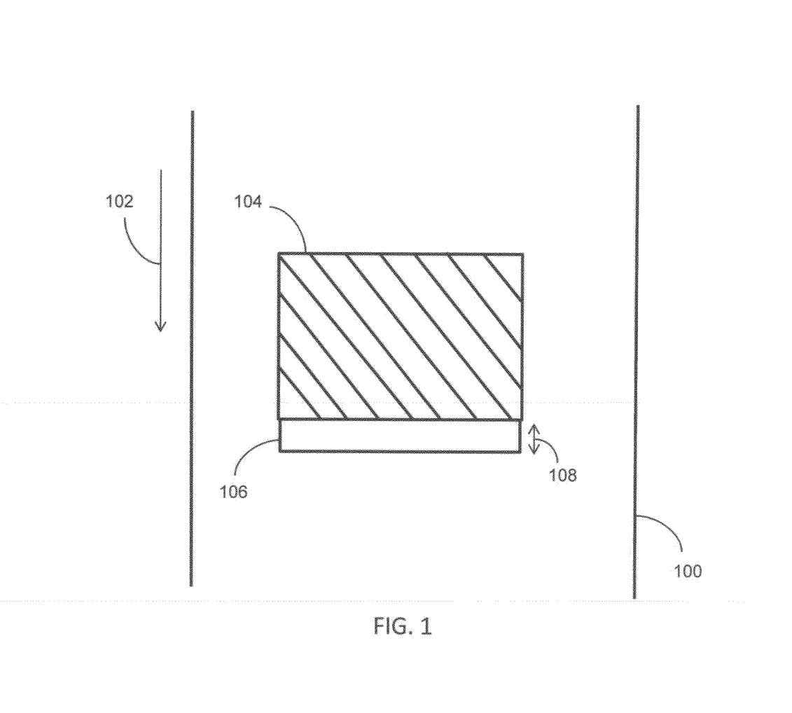

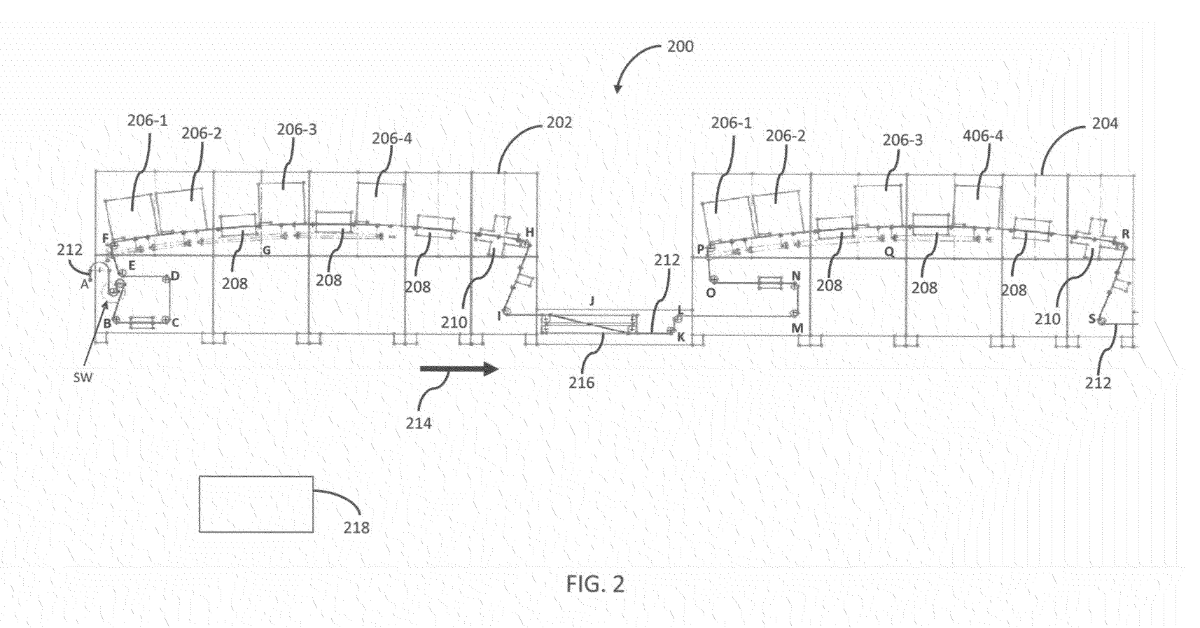

The terms “upstream” and “downstream” are terms of art referring to relative positions along the transport path of the web; points on the transport path move from upstream to downstream. In FIGS. 1 and 2 the web moves in a direction indicated by feed direction arrow 102. Where they are used, terms such as “first”, “second”, and so on, do not necessarily denote any ordinal or priority relation, but are simply used to more clearly distinguish one element from another.

Referring now to FIG. 1, there is shown a graphical illustration of in-track color misalignment. As a continuous web 100 is transported through a printing system in the feed direction 102, the lineheads (not shown) jet ink onto the web 100. Typically, each linehead jets ink of one color, and the color printed on the web is known as a color plane. The ink colors of all of the lineheads combined form the printed content.

The web 100 can receive a large amount of ink during printing, especially with water-based ink or in high ink laydown regions of the printed content (e.g. a picture with a lot of dense black background). In turn, the aqueous component of the ink can be absorbed into the web and can cause the web to swell and stretch, especially if the web is under tension. Stretch is usually significantly higher in the direction of movement (i.e., the feed or in-track direction) compared to the cross-track direction.

Additionally, heat is typically applied at one or more locations in a printing system to dry the ink that has been applied to the continuous web 100. Drying of the web can cause the web to shrink. When the web is heated in between lineheads, regions of the web can be stretched and shrunk one or more times as the web moves through a printing system.

Printing with several color planes in which each color record is printed sequentially requires color laydown correlation or registration. Unanticipated or unaccounted for stretch or shrink in the web can cause a loss of color registration and can lead to blurry content or hue degradation.

In the illustrated embodiment, one color plane 104 has been printed over another color plane 106. The web 100 stretched in the in-track direction between the printing of color plane 106 and color plane 104. The in-track stretch resulted in color misregistration 108 between the two color planes 104, 106. Embodiments in accordance with the invention provide a method for controlling tension in a continuous web in a web transport system of a printing system. Controlling the tension in the web can reduce or eliminate color or image misregistration.

FIG. 2 illustrates one example of a continuous web printing system. Printing system 200 includes a first printing module 202 and a second printing module 204, each of which includes lineheads 206, dryers 208, and a quality control sensor 210. Each linehead 206 typically includes multiple printheads (not shown) that apply ink or another liquid to the surface of the continuous web of web 212 that is adjacent to the printheads. For descriptive purposes only, the lineheads 206 are labeled a first linehead 206-1, a second linehead 206-2, a third linehead 206-3, and a fourth linehead 206-4. In the illustrated embodiment, each linehead 206-1, 206-2, 206-3, and 206-4 applies a different colored ink to the surface of the web 212 that is adjacent to the lineheads. By way of example only, linehead 206-1 applies cyan colored ink, linehead 206-2 magenta colored ink, linehead 206-3 yellow colored ink, and linehead 206-4 black colored ink.

The first printing module 202 and the second printing module 204 also include a web tension system that serves to physically move the continuous web 212 through the printing system 200 in the feed direction 214 (left to right as shown in the figure). The web 212 enters the first printing module 202 from a source roll (not shown) and the linehead(s) 206 of the first module applies ink to one side of the web 212. As the web 212 feeds into the second printing module 204, a turnover module 216 is adapted to invert or turn over the web 212 so that the linehead(s) 206 of the second printing module 204 can apply ink to the other side of the web 212. The web 212 then exits the second printing module 204 and is collected by a receiving unit (not shown).

First printing module 202 has a support structure that includes a cross-track positioning mechanism (A) for positioning the continuously moving web in the cross-track direction, that is, orthogonal to the feed direction in the plane of travel. In one embodiment, cross-track positioning mechanism (A) is an edge guide for registering an edge of the moving web. An S-wrap device (SW), affixed to the support structure of first module 202, includes structure that sets the tension of the web.

Downstream from the first printing module 202 along the path of the web 212, the second printing module 204 also has a support structure similar to the support structure for first printing module 202. Affixed to the support structure of either or both the first or second module is a kinematic connection mechanism that maintains the kinematic dynamics of the web 212 in traveling from the first printing module 202 into the second printing module 204. Also affixed to the support structure of either the first or second module are one or more angular constraint structures for setting an angular trajectory of the web 212.

Table 1 that follows identifies the lettered components used for web transport as shown in FIG. 2. An edge guide (A) is provided in which the web 212 is pushed laterally so that an edge of the web contacts a stop. The slack web entering the edge guide (A) allows the web 212 to be shifted laterally without interference and without being over-constrained. The S-wrap device (SW) provides stationary curved surfaces over which the continuous web 212 slides during transport. As the web 212 is pulled over these surfaces, the friction of the web 212 across these surfaces produces tension in the web. In one embodiment, the S-wrap device (SW) is adapted to adjust the positional relationship between surfaces, to control the angle of wrap and to allow adjustments in the tension of the web.

TABLE 1
Roller Listing for FIG. 2

| Media Handling | |
|---|---|
| Component | Type of Component |
| A | Lateral Constraint (edge guide) |
| SW | S-wrap device |
| B | In-Feed Drive Roller |
| C | Castered and Gimbaled Roller |
| D | Gimbaled Load Cell Roller |
| E | Servo-Castered and Gimbaled Roller |
| F | Fixed Roller (tach) |
| G | Rainbow Rollers (Qty = 17, 8 linehead, |
| | 6 dryer, 3 QC) |
| H | Servo-Castered and Gimbaled Roller |
| I | Gimbaled Roller |
| J | Turnover Mechanism Drive Roller |
| K | Castered and Gimbaled Roller |
| L | Gimbaled Roller |
| M | Castered and Gimbaled Roller |
| N | Gimbaled Load Cell Roller |
| O | Servo-Castered and Gimbaled Roller |
| P | Fixed Roller (tach) |
| Q | Rainbow Rollers (Qty = 17, 8 linehead, |
| | 6 dryer, 3 QC) |
| R | Servo-Castered and Gimbaled Roller |
| S | Out-Feed Drive Roller |

The first angular constraint is provided by in-feed drive roller (B). This is a fixed roller that cooperates with a drive roller (J) in the turnover module 216 and with an out-feed drive roller (N) in second printing module 204 in order to move the web 212 through the printing system 200 with suitable tension in the feed direction 214. The tension provided by the preceding S-wrap device (SW) serves to hold the web 212 against the in-feed drive roll. Angular constraints at subsequent locations downstream along the web 212 are provided by rollers that are gimbaled so as not to impose an angular constraint on the next downstream media span.

Processing device 218 can be connected to various components in the web tension system and the processing device 218 is adapted to transmit data to, and receive data from, the various components. Processing device 218 can be used to control the positions or speeds of some of the components, such as the in feed drive roller and the out feed drive roller. Additionally, processing device 218 can receive tension measurements or data from the load cell roller. Processing device 218 can be connected to components in printing system 200 using any known wired or wireless communication connection. Processing device 218 can be separate from printing system 200 or integrated within printing system 200 or within a component in printing system 200.

Although FIG. 2 depicts each printing module with four lineheads 206, three dryers 208, and one quality control sensor 210, embodiments in accordance with the invention are not limited to this construction. A printing system can include any number of lineheads, any number of dryers, and any number of quality control sensors. The printing system can also include a number of other components, including, but not limited to, web cleaners and web tension sensors.

And although the printing system shown in FIG. 2 has the turnover module 216 disposed between the first and second printing modules 202, 204, other printing systems can include the turnover module within one of the printing modules.

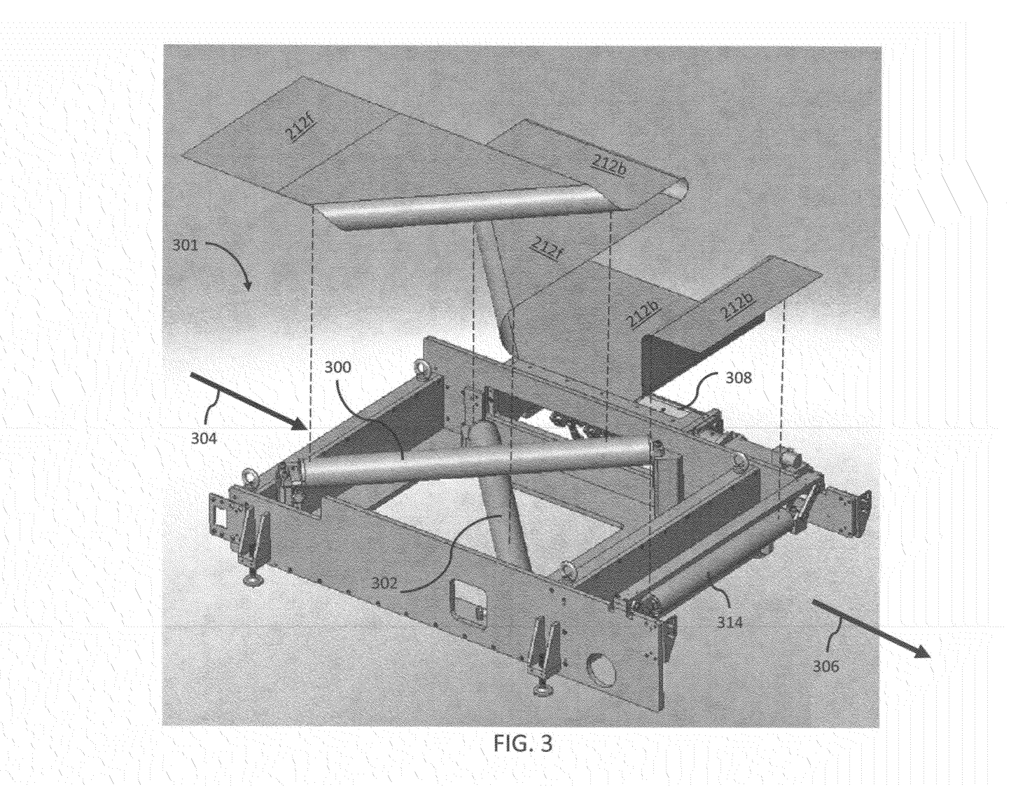

FIG. 3 illustrates a top perspective view of one example of a turnover module in an embodiment in accordance with the invention. Turnover module 301 includes stationary turnbars 300, 302 positioned at diagonals to the input path 304 and the output path 306. One or more turnbars can be included in other embodiments in accordance with the invention. For example, one turnbar can be included in a turnover module that also redirects the web ninety degrees.

In FIG. 3, the front side of the web is identified as 212f and the back side of the web as 212b. The web 212 enters along the input path 304 with ink or another liquid jetted onto a front side of the web 212f. The web 112 then wraps around stationary turnbar 300 and passes to driver roller 308 of the turnover mechanism, where the web wraps around a driver roller 308. The web 212 exits driver roller 308 front side up, as shown in region 310. The web 212 then wraps around stationary turnbar 302 and is directed along the output path 306. The web 212 has now been inverted or turned over (see region 312) and the back side of the web 212b is positioned to receive ink from the linehead(s) in the next printing module (e.g., printing module 204 in FIG. 2). The web 212 passes over bar 314 and exits the turnover module 216 along the output path 306.

Embodiments in accordance with the invention employ two different tension control modes, an active tension control mode and a synchronized tension control mode. In active tension control mode, the speed of one or more rollers is controlled and adjusted to compensate for increasing and decreasing tension in the web. In the embodiment illustrated in FIG. 2, the turnbar drive roller (J) in the turnover module 216 (e.g., turnbar 308 in FIG. 3) is set to turn at a constant speed. Tension is produced in the web in the first printing module 202 with S-wrap device (SW). The speed of the in-feed drive roller (B) is adjusted from the speed of the turnbar driver roller (J) based on the amount of tension measured or sensed in the web in a first tension zone by load cell roller (D). The tension in the web in the first tension zone decreases when the speed of the in-feed drive roller increases. The tension in the web in the first tension zone increases when the speed of the in-feed drive roller decreases. The first tension zone is the zone between the in-feed drive roller (B) and the turnbar drive roller (J) in the turnover module 216 in an embodiment in accordance with the invention.

In the second printing module 204, the speed of the out-feed drive roller (S) is adjusted from the speed of the turnbar driver roller (J) in the turnover module 216 based on the amount of tension measured or sensed in the web in a second tension zone by load cell roller (N). The tension in the web in the second tension zone increases when the speed of the out-feed drive roller increases. The tension in the web in the second tension zone decreases when the speed of the out-feed drive roller decreases. The second tension zone is the zone between the turnbar driver roller (J) in the turnover module 216 and the out-feed drive roller (S) in an embodiment in accordance with the invention.

In synchronized tension control mode, the speed of the in-feed drive roller (B) is synchronized with the speed of the turnbar drive roller (J) in the turnover module 216 and the speed of the out-feed drive roller (S) is synchronized with the turnbar driver roller (J). In one embodiment, the synchronization of the in-feed drive roller with the turnbar driver roller (J) can occur independently of the synchronization of the out-feed drive roller with the turnbar driver roller (J). If the tension in the web in the first or second tension zone increases or decreases, the speeds of the in-feed drive roller (B) and the out-feed drive roller (S) are adjusted to compensate for the change in tension. In one embodiment, the speeds of the in-feed drive roller (B) and the out-feed drive roller (S) are only slightly adjusted with other constraints to compensate for the change in tension.

Other embodiments in accordance with the invention can produce tension in a continuous web differently or can adjust the settings or operation of different components based on tension changes in the web. The components that are adjusted based on tension changes in the web can vary depending on the system and the web transport system.

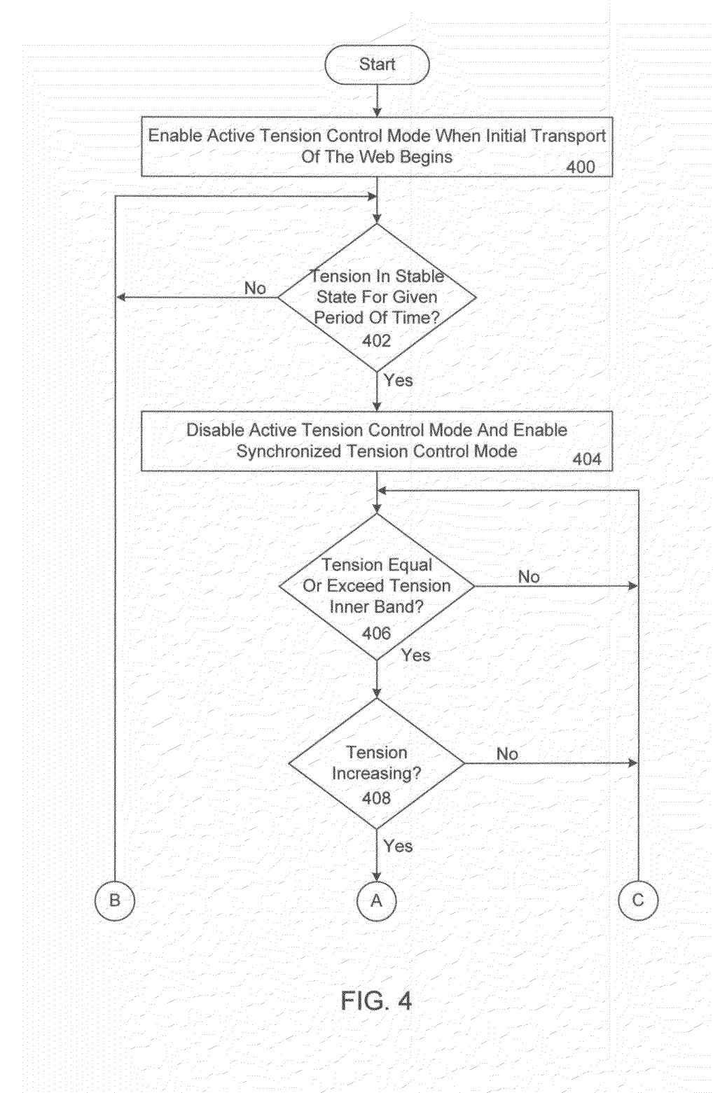

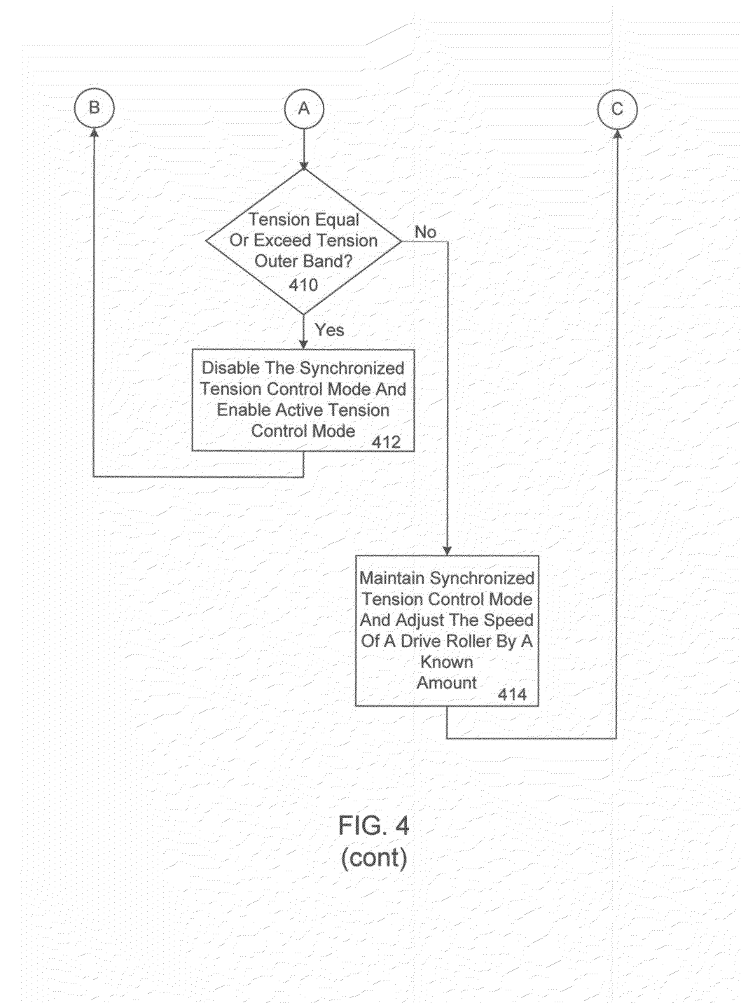

Referring now to FIG. 4, there is shown a flowchart of a method for controlling tension in a continuous web in a web transport system in an embodiment in accordance with the invention. As discussed earlier, the web tension system is adapted to enable and disable both an active tension control mode and a synchronized tension control mode. Initially, the active tension control mode is enabled and the synchronized tension control mode disabled when initial transport of the web begins (block 400). For example, the active tension control mode is enabled when a print job begins or when the web transport system is started after a change of web.

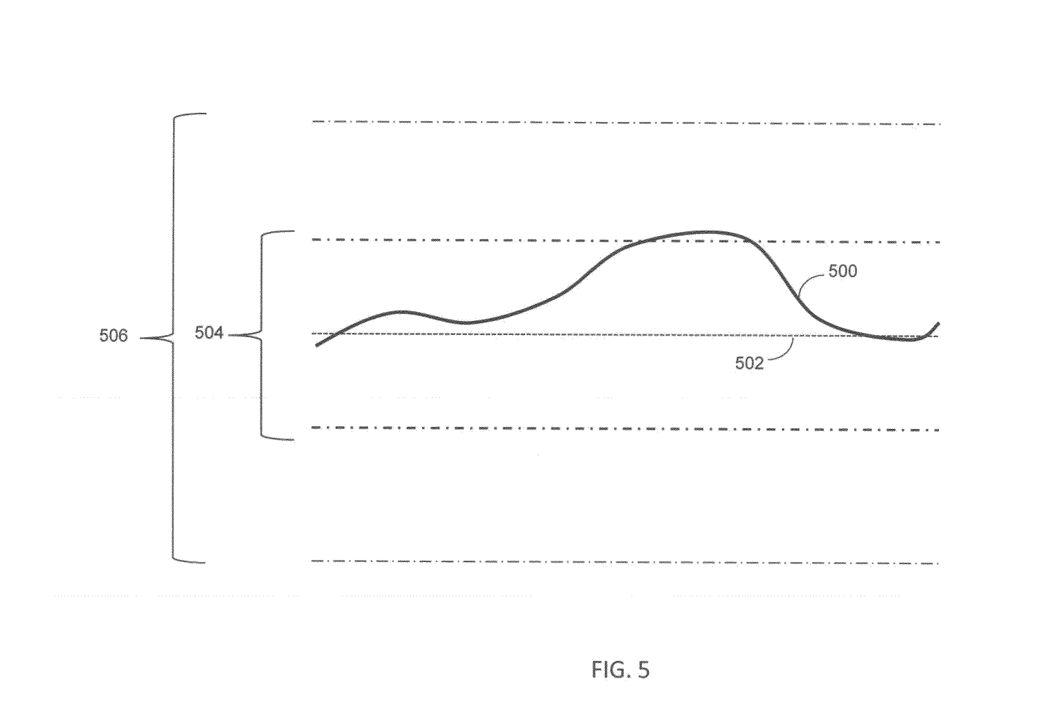

The active tension control mode is in operation until the tension in the web in a tension zone is in a stable state for a given period of time. So a determination is made at block 402 as to whether or not the tension in the web in a tension zone is in a stable state. The stable state is described in conjunction with FIG. 5. The tension 500 in the web in a tension zone is actively controlled to reach a target tension 502 or to be within a given tolerance of the target tension 502. By way of example only, the speed of the in-feed drive roller (B) or the speed of the out-feed drive roller (S) is adjusted until the tension in the web reaches the target tension.

The stable state is achieved when the tension in the web in a tension zone is stable for a given period of time. “Stable” is defined as having the tension within a tension outer band (e.g., see 506 in FIG. 5), and the given period of time is twelve seconds in an embodiment in accordance with the invention. By way of example only, a processing device (e.g., processing device 218 in FIG. 2) can be used to determine if the tension is in the stable state for the given period of time. Other embodiments in accordance with the invention can determine the given period of time to be any amount of time.

If the tension is not in the stable state, the process waits until the tension in the web in a tension zone is in the stable state for the given amount of time. The method then passes to block 404 where the active tension control mode is disabled and the synchronized tension control mode enabled. While in the synchronized tension control mode, a determination is made at block 406 as to whether or not the tension in the web in a tension zone equals or exceeds a tension inner band. By way of example only, a processing device (e.g., processing device 218 in FIG. 2) can be used to determine if the tension equals or exceeds the tension inner band.

One example of a tension inner band 504 is depicted in FIG. 5. In the illustrated embodiment, the tension inner band is +/−5% of the target tension. Other embodiments can determine the tension inner band differently. For example, the tension inner band can be +/−N, where N is any value; or the tension inner band can be +N and −M, where N and M are any different values.

If the tension in the web in a tension zone does not equal or exceed the tension inner band, the process continues in the synchronized tension control mode. If the tension in the web in a tension zone equals or exceeds the tension inner band, a determination is made at block 408 as to whether or not the tension in the web is increasing. If the tension in the web in a tension zone is not increasing, the method continues in the synchronized tension control mode.

If the tension in the web in a tension zone is increasing, a determination is made at block 410 as to whether or not the tension in the web in a tension zone equals or exceeds a tension outer band. By way of example only, a processing device (e.g., processing device 218 in FIG. 2) can be used to determine if the tension is increasing or if the tension equals or exceeds the tension outer band.

One example of a tension outer band 506 is shown in FIG. 5. In the illustrated embodiment, the tension outer band is +/−11% of the target tension. Other embodiments can determine the tension outer band differently. For example, the tension outer band can be +/−X, where X is any value; or the tension outer band can be +X and −Y, where X and Y are any different values.

If the tension in the web in a tension zone does not equal or exceed the tension outer band, the process continues at block 414 where the synchronized tension control mode is maintained but the speed of the controlling drive roller for the associated tension zone is adjusted by a known amount. The method then returns to block 406. The synchronized tension control mode continues as long as the tension in the web in a tension zone is within the tension outer band.

In one embodiment in accordance with the invention, the speed of the controlling drive roller for the associated tension zone is adjusted in incremental steps, such as, for example, 0.005% increments. In one embodiment, the adjustment of the speed of the controlling drive roller stops when the tension in the web in a tension zone is within the tension inner band or the tension in the web in a tension zone equals or exceeds the tension inner band but the tension in the web is decreasing.

If the tension in the web in a tension zone equals or exceeds the tension outer band, the process passes to block 412 where the synchronized tension control mode is disabled and the active tension control mode is enabled. The method then returns to block 402, where the process waits until the tension in the web in a tension zone is in the stable state for the given amount of time. The method can then repeat for the duration of a print job.

Other embodiments in accordance with the invention can add additional blocks to the illustrated method or can delete some blocks. By way of example only, block 408 can be deleted in another embodiment in accordance with the invention.

The invention has been described in detail with particular reference to certain embodiments thereof, but it will be understood that variations and modifications can be effected within the spirit and scope of the invention. As described earlier, other embodiments in accordance with the invention can control tension in different types of webs transported by different types of web transport systems in different types of systems. And even though specific embodiments of the invention have been described herein, it should be noted that the application is not limited to these embodiments. In particular, any features described with respect to one embodiment may also be used in other embodiments, where compatible. The features of the different embodiments may be exchanged, where compatible.

A method for controlling tension in a print media in a tension zone of a continuous web printing system comprises enabling an active tension control mode when initial transport of the print media begins and until the tension in the print media in the tension zone is in a stable state for a given period of time and disabling the active tension control mode and enabling a synchronized control mode after the tension in the print media in the tension zone is in the stable state for the given period of time.

If the tension in the print media in the tension zone exceeds a tension inner band while in the synchronized control mode, a speed of a drive roller is adjusted by a known amount until the tension in the print media in the tension zone is within the tension inner band. If the tension in the print media in the tension zone exceeds a tension outer band while in the synchronized control mode, the synchronized control mode is disables and the active tension control mode is enabled until the tension in the print media in the tension zone returns to the stable state for the given period of time.

The method described above can further comprise disabling the active tension control mode and enabling the synchronized control mode after the tension in the print media in the tension zone returns to the stable state for the given period of time. In the method described above, adjusting a speed of a drive roller by a known amount until the tension in the print media in the tension zone is within the tension inner band comprises repeatedly adjusting a speed of a drive roller by a known amount until the tension in the print media in the tension zone is within the tension inner band, the adjustment step being performed once a known time period.

When the tension in the print media in the tension zone exceeds a tension inner band and the tension in the print media in the tension zone is increasing while in the synchronized control mode, the speed of a drive roller is adjusted by a known amount until the tension in the print media in the tension zone is within the tension inner band. In various aspects of the present invention, the known amount can be fixed or variable.

### PARTS LIST

100 web
102 feed direction
104 color plane
106 color plane
108 color misregistration
200 printing system
202 printing module
204 printing module
206 linehead
208 dryer
210 quality control sensor
212 web
214 feed direction
216 turnover module
218 processing device
300 turnbar
301 turnover module
302 turnbar
304 input path
306 output path
308 driver roller
314 bar
400 enable active tension control mode
402 determine if tension in stable state
404 switch to synchronized control mode
406 monitor tension with respect to inner tension band
408 monitor deviation of tension from target
410 monitor tension with respect to outer tension band
412 switch to active tension control mode
414 adjust drive rollers in synchronized control mode
500 plot of tension in web
502 target tension
504 tension inner band
506 tension outer band

1. A method for controlling tension in a print media in a tension zone of a continuous web printing system, comprising:
enabling an active tension control mode when initial transport of the print media begins and until the tension in the print media in the tension zone is in a stable state for a given period of time;
disabling the active tension control mode and enabling a synchronized control mode after the tension in the print media in the tension zone is in the stable state for the given period of time;
monitoring the tension in the print media in the tension zone to determine if the tension exceeds a tension inner band and does not exceed a tension outer band while the synchronized control mode is enabled and adjusting a speed of a drive roller in response to the determination that the tension exceeds the tension inner band and does not exceed the tension outer band; and
monitoring the tension in the print media in the tension zone to determine if the tension exceeds the tension outer band while the synchronized control mode is enabled, disabling the synchronized control mode in response to the determination that the tension exceeds the tension outer band, and enabling the active tension control mode.

2. The method according to claim 1, further comprising disabling the active tension control mode and enabling the synchronized control mode after the tension in the print media in the tension zone returns to the stable state for the given period of time.

3. The method according to claim 1, wherein adjusting a speed of a drive roller in response to the determination that the tension exceeds the tension inner band and does not exceed the tension outer band, further includes adjusting the speed of the drive roller by a known amount until the tension in the print media in the tension zone is within the tension inner band.

4. The method according to claim 1, wherein enabling the active tension control mode in response to the determination that the tension exceeds the tension outer band, further includes enabling the active tension control mode until the tension in the print media in the tension zone returns to the stable state for the given period of time.

5. The method according to claim 1, wherein the tension outer band is larger than the tension inner band.

6. The method according to claim 1 wherein the known amount of speed adjustment in the synchronized control mode comprises a known percent change in the speed of a drive roller.

7. The method according to claim 1, wherein monitoring the tension in the print media in the tension zone to determine if the tension exceeds a tension inner band while the synchronized control mode is enabled further comprises determining if the deviation of the tension in the web from the target value is increasing, and adjusting a speed of a drive roller, in response to the determination, by a known amount until the tension in the print media in the tension zone is within the tension inner band.

8. The method according to claim 3 further comprising adjusting repeatedly the speed of the drive roller by the known amount until the tension in the print media in the tension zone is within the tension inner band.

9. The method according to claim 3, wherein the known amount comprises a fixed known amount.

10. The method according to claim 3, wherein the known amount comprises a variable known amount.
